(19) United States
(12) Patent Application Publication
(10) Pub. No.: US 2014/0172738 A1
(43) Pub. Date: Jun. 19, 2014

(54) KNOWLEDGE BASED INITIALIZATION FOR ROUTING OPTIMIZATION

(71) Applicants: Thomas Schulz, Speyer (DE); Kathrin Dyckerhoff, Walldorf (DE); Thomas Engelmann, Walldorf (DE); Christoph Eckert, Muehlhausen (DE)

(72) Inventors: Thomas Schulz, Speyer (DE); Kathrin Dyckerhoff, Walldorf (DE); Thomas Engelmann, Walldorf (DE); Christoph Eckert, Muehlhausen (DE)

(21) Appl. No.: 13/715,167

(22) Filed: Dec. 14, 2012

(51) Int. Cl. G06Q 10/08

(52) U.S. Cl. CPC G06Q 10/08355
USPC 705/338

(57) ABSTRACT

According to one general aspect, a method of transportation management may include receiving a request to transport a current freight unit from a current source location to a current destination location. The method may include selecting a prior shipment path based upon a similarity, as defined by a set of predefined criteria, between the current freight unit and a prior freight unit. The method may further include initializing a shipment path improver with the prior shipment path. The method may also include generating, via the shipment path improver, a current shipment path for the current freight unit from the current source location to the current destination location based upon the prior shipment path.

### TECHNICAL FIELD

This description relates to transportation management, and more specifically, to the optimization of routing of freight or other objects.

### BACKGROUND

One aspect of transportation management includes vehicle scheduling and routing (VSR). In vehicle scheduling and routing (VSR) a frequent goal is to find the cost optimal solution for the transport of several freight units by using several vehicles (e.g., trucks, ships, airplanes, trains, etc.) which are traveling various routes.

The optimal solution, however, is rarely or infrequently found because of the huge complexity of the underlying mathematical problem. One example of such a problem that is well known is the traveling salesperson problem (TSP). Hence, a so called optimizer is often used to find the best possible solution to the problem in a given period of computation time.

### SUMMARY

According to one general aspect, a method of transportation management may include receiving a request to transport a current freight unit from a current source location to a current destination location. The method may include selecting a prior shipment path based upon a similarity, as defined by a set of predefined criteria, between the current freight unit and a prior freight unit. The method may further include initializing a shipment path improver with the prior shipment path. The method may also include generating, via the shipment path improver, a current shipment path for the current freight unit from the current source location to the current destination location based upon the prior shipment path.

According to another general aspect, an apparatus may include a processor and a network interface. The network interface may be configured to receive a request to transport a current freight unit from a current source location to a current destination location. The processor may be configured to select a prior shipment path based upon a similarity, as defined by a set of predefined criteria, between the current freight unit and a prior freight unit, initialize a shipment path improver with the prior shipment path, and generate, via the shipment path improver, a current shipment path for the current freight unit from the current source location to the current destination location based upon the prior shipment path.

According to another general aspect, a computer program product for transportation management may be tangibly and non-transitorily embodied on a computer-readable medium. The computer program product may include executable code that, when executed, is configured to cause an apparatus to: receive a request to transport a current freight unit from a current source location to a current destination location; select a prior shipment path based upon a similarity, as defined by a set of predefined criteria, between the current freight unit and a prior freight unit; initialize a shipment path improver with the prior shipment path; and generate, via the shipment path improver, a current shipment path for the current freight unit from the current source location to the current destination location based upon the prior shipment path.

The details of one or more implementations are set forth in the accompanying drawings and the description below. Other features will be apparent from the description and drawings, and from the claims.

A system and/or method for managing transportation, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a diagram of an example embodiment of a shipment path in accordance with the disclosed subject matter.

FIG. 3 is a diagram of an example embodiment of a shipment path in accordance with the disclosed subject matter.

FIG. 4 is a diagram of an example embodiment of a shipment path in accordance with the disclosed subject matter.

FIG. 5 is a flow chart of an example embodiment of a technique in accordance with the disclosed subject matter.

Like reference symbols in the various drawings indicate like elements.

### DETAILED DESCRIPTION

In this context, a “freight unit” includes any object or thing that is to be shipped, transported, or moved from a source or initial location to a destination location. While most examples and embodiments used herein describe freight units that include products or inventory items (e.g., televisions, bales of wire, barrels of paint, etc.), it is understood that they are merely a few illustrative examples to which the disclosed subject matter is not limited. In various embodiments, a freight unit may also include people (e.g., passengers, etc.), foodstuffs (e.g., vegetables, meat, etc.), or other physical objects.

In this context, a “shipment path” is the route that may be taken by a freight unit or units from the source or initial location to a destination location. In various embodiments, the shipment path may include one or more modes of transportation (e.g., truck, ship, train, airplane, etc.) that may be used by the freight unit. In some embodiments, the shipment path may include a time table as to when these modes of transportation will be used (e.g., 12:00 pm on Monday Mar. 12, 2012, etc.). In another embodiment, the shipment path may include one or more intermediate destinations, waypoints, or locations (e.g., a city or port where the freight unit changes from one transportation mode to another, a customs checkpoint, etc.). In various embodiments, the shipping route may include a data structure such as, for example, an array, a list, etc. It is understood that the above are merely a few illustrative examples to which the disclosed subject matter is not limited.

In one embodiment, a shipment path optimization technique is performed in two phases. In a first phase, an initialization may be done for the freight unit. In one example, the freight unit may be assigned to a somewhat randomly generated shipment path. In such an embodiment, the shipment path may involve the freight unit being placed on somewhat randomly selected vehicles which are able to transport to the freight units to their final destination. In some embodiments, this first phase may be performed using greedy algorithms to quickly find a valid but not necessarily cost efficient solution.

In such an embodiment, in a second phase, an actual optimization may be performed. In this step the optimization algorithms may run or execute for a remaining period of computation time. As described above, a “perfect” optimization may involve an unacceptable amount of computation processing. In such an embodiment, a user or controller of the transportation management process may limit the amount of computation processing or time used. In such an embodiment, the user may determine that the results after a limited or truncated optimization process may be “good enough” or sufficiently optimized, while not being “perfect”.

In various embodiments, the optimization phase may include trying to improve or optimize the initial solution or shipment path towards a more and more desirable (e.g., less costly, more effecting, faster, etc.) solution or shipping path. In some embodiments, may be done via genetic algorithms. In various embodiments, the optimization may be achieved by making small changes to the initial or current shipment path which creates or generates to a different shipment path. In case in which the cost of the changed shipment path is less than the cost of the unchanged shipment path (or more desirable based on a selected metric), then the changed shipment path will replace or be used as the current shipment path. In various embodiments, this alteration and replacement process may repeat until a predefined criteria (e.g., amount of computation time, shipment path efficiency, etc.) is reached.

In this context, it is understood that the term “optimization” means the improvement of a result (e.g., a shipment path) and not mean an ideal or perfect solution or result. In various embodiments, the optimization process may in fact result in a perfect or ideal result, but more often, due to the predefined criteria (e.g., amount of computation time, etc.) the result of the optimization process may only be an improvement upon the initial result or solution (e.g., the initial shipping path). In some embodiments, the optimization process may result in no improvement over the initial result at all; however, it is understood that the function of the optimization process is to attempt to improve the result or shipping path.

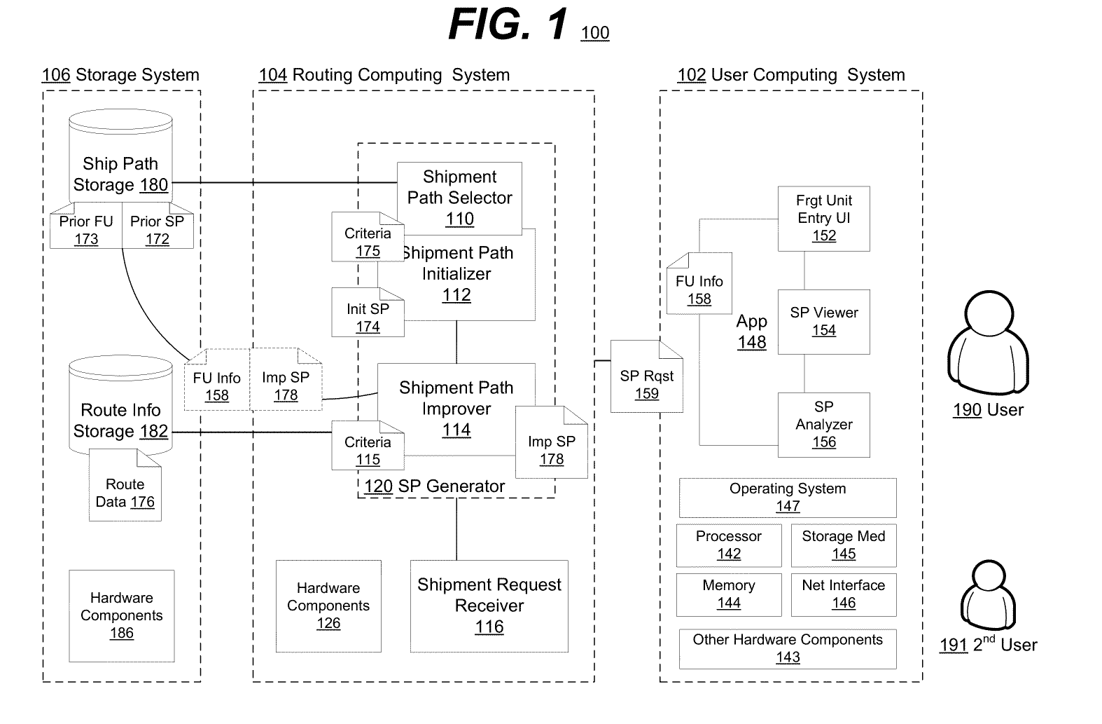

FIG. 1 is a block diagram of an example embodiment of a system 100 in accordance with the disclosed subject matter. In various embodiments, the system 100 may include a user device or computing system 102, a routing device or computing system 104, and/or one or more storage systems 106.

In various embodiments, the user device 102 may include a computing device, such as, for example, a laptop, desktop, workstation, personal digital assistant, smartphone, tablet, and other appropriate computers, etc. or a virtual machine or virtual computing device thereof. In various embodiments, the user device 102 may be used by a user 190. In various embodiments, the user device 102 may include a processor 142 configured to execute one or more machine executable instructions or pieces of software, firmware, or a combination thereof. The user device 102 may include, in some embodiments, a memory 144 configured to store one or more pieces of data, either temporarily, permanently, semi-permanently, or a combination thereof. Further, the memory 144 may include volatile memory, non-volatile memory or a combination thereof. In various embodiments, the user device 102 may include a storage medium 145 configured to store data in a semi-permanent or substantially permanent form. In various embodiments, the storage medium 145 may be included by the memory 144.

In various embodiments, the user device 102 may include one or more network interfaces 146 configured to allow the user device 102 to be part of and communicate via a communications network. Examples of a Wi-Fi protocol may include, but are not limited to: Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to: IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

In various embodiments, the user device 102 may include one or more other hardware components 143 (e.g., a display or monitor, a keyboard, a mouse, a camera, a fingerprint reader, a video processor, etc.). It is understood that the above are merely a few illustrative examples to which the disclosed subject matter is not limited.

In various embodiments, the user device 102 may include an operating system (OS) 147 configured to provide one or more services to an application 148 and manage or act as an intermediary between the application 148 and the various hardware components (e.g., the processor 142, a network interface 146, etc.) of the user device 102. In such an embodiment, the user device 102 may include one or more native applications, which may be installed locally (e.g., within the storage medium 145, etc.) and configured to be executed directly by the processor 142 and directly interact with the OS 147. In such an embodiment, the native applications may include pre-compiled machine executable code. In some embodiments, the native applications may include a script interpreter (e.g., C shell (csh), AppleScript, AutoHotkey, etc.) or a virtual execution machine (VM) 111 (e.g., the Java Virtual Machine, the Microsoft Common Language Runtime, etc.) that are configured to translate source or object code into executable code which is then executed by the processor 142.

In one embodiment, the user 190 may wish or desire to ship, transport, or physically move a physical object, described herein as a “freight unit”. In the illustrated embodiment, the application 148 may provide the user 190 with a way to manipulate, manage, or arrange the shipment freight units. In one embodiment, the application may include a freight unit entry user interface (UI) 152. In such an embodiment, the user 190 may be able to create or edit a freight unit information or ticket 158.

In various embodiments, the freight unit (FU) information or ticket 158 may indicate what freight unit or object (e.g, an inventory item, bales of wire, boxes of widgets, etc.) is to be shipped. In some embodiments, the freight unit ticket 158 may also include the quantity or amount of the freight unit being shipped. In some embodiments, the freight unit ticket 158 may include a source location or address from which the freight unit is to start the shipment process (e.g., 1 Microsoft Way, Redmond, Wash.; Circular Quay, Sydney, NSW; Lisbon; etc.). In some embodiments, the freight unit ticket 158 may include a destination location or address to which the freight unit is to end the shipment process.

In various embodiments, the FU ticket 158 may include a plurality of different freight units (e.g., red paint & blue paint; lumber, nails, & shingles; etc.). In such an embodiment, the freight units may all originate from the same source location or address and be shipped to the same destination location or address.

In another embodiment, the FU ticket 158 may include a plurality of FU tickets 158 or portions of other FU tickets. In such an embodiment, the total journey any given FU takes may be broken up into a plurality of FU tickets, or alternatively a plurality of FU tickets may be combined into one or more shared FU tickets 158.

For example, in one embodiment, a plurality of FUs may have different source locations but may share a common destination location. In such an embodiment, the user 190 or other entity may desire that the different FUs meet at a common intermediate location during their individual shipments to the common destination and from there journey together to the destination location. In such an embodiment, the FU tickets for each FU may be divided into two FU tickets, a first FU ticket from the individual source location to the common intermediate location (the destination location for that FU ticket) and a second FU ticket that includes all of the FUs from the common intermediate location (the source location for the shared FU ticket) to the final destination ticket. It is understood that the above is merely one illustrative example to which the disclosed subject matter is not limited.

In one embodiment, the freight unit ticket 158 or other information regarding the freight unit may be transmitted to the routing computing system 104. In some embodiments, the user device 102 and the routing computing system 104 may be integrated or a single machine or device. In various embodiments, the routing computing device 104 may be configured to determine or generate a shipment path or route 178 for the freight unit to take or journey upon between the freight unit's source location to the freight unit's destination location.

In some embodiments, the FU ticket 158 may include one or more shipment constraints. In some embodiments, a shipment constraint may include one or more restrictions on the form of travel FU may take (e.g., may not use boats, may not use Company X, etc.). In another embodiment, a shipment constraint may include a time based limitation (e.g., the freight unit must arrive at the destination within 2 days, the freight unit must not arrive before June 1^{st}, etc.). In yet another embodiment, the shipment constraint may include a legal based limitation (e.g., a customs restriction, a requirement to avoid a country due to legal reason, etc.). In one embodiment, the shipment constraint may include a care or handling based limitation (e.g., a refrigerated containers must be used; the freight unit includes perishable material; etc.). It is understood that the above are merely a few illustrative examples to which the disclosed subject matter is not limited. In various embodiments, the routing device 104 may be configured to improve or optimize the route and shipping methods (e.g., truck, train, boat, plane, etc.) used to ship the freight unit from the source to the destination.

In various embodiments, the routing device 104 may include a computing device, such as, for example, a laptop, desktop, workstation, personal digital assistant, tablet, blade server, and other appropriate computers, etc. or a virtual machine or virtual computing device thereof. In various embodiments, the routing device 104 may include a plurality of hardware components 126 (e.g., processor, memory, network interface, etc.) similar to that described above in reference to the user computing system 102

In some embodiments, the routing device 104 may include a shipment request receiver 116, and a shipment path generator 120. In various embodiments, the routing device 104 may include a shipment selector 110.

In one embodiment, the application 148 may send a shipment request 159 to the routing device 104. In such an embodiment, the shipment request 159 may include the FU ticket 158 or a portion of the FU information 158. In some embodiments, the shipment request 159 may include multiple FU tickets 158. In various embodiments, the shipment request 159 may be received by the shipment request receiver 116.

In various embodiments, the routing device 104 may include a shipment path generator 120 configured to generator or create a shipping path 178. In the illustrated embodiment, the shipment path generator 120 may include a shipment path initializer 112 and a shipment path improver 114. In various embodiments, these two sub-components 112 and 114 may reflex a two phase shipment path optimization technique, as described above. It is understood that the above is merely one illustrative example to which the disclosed subject matter is not limited.

In one embodiment, the shipment path initializer 112 may be configured to generate, provide, or acquire an initial shipment path 174. In various embodiments, the initial shipment path 174 may simple be a shipment path that allows the freight unit (described in the FU ticket 158 or shipment request 159) to be shipped or transported from its source location to the destination location. In some embodiments, the initial shipment path 174 may be a shipment path chosen at random, a predefined shipment path, or a somewhat randomly shipment path generated using some predefined criteria (e.g., use land transportation, take the shortest route, etc.). However, in the illustrated embodiment, the shipment path initializer 112 may select a prior shipment path 172, as described below.

In such an embodiment, the shipment path initializer 112 may include a shipment path selector 110. In such an embodiment, the shipment path selector 110 may be configured to select a pre-existing or prior shipment path 172 from among a plurality of prior or candidate shipment paths. This selected prior shipment path 172 may then serve as the initial shipment path 174.

In some embodiments, the system 100 may include a storage system or device 106. In various embodiments, the storage device 106 may include a computing device, such as, for example, a laptop, desktop, workstation, personal digital assistant, tablet, blade server, and other appropriate computers, etc. or a virtual machine or virtual computing device thereof. In various embodiments, the storage device 106 may include a plurality of hardware components 186 (e.g., processor, memory, network interface, etc.) similar to that described above in reference to the user computing system 102. In some embodiments, the storage system 106 may include a plurality of different systems or devices, not shown.

In various embodiments, the storage system 106 may include a database or repository 180 of prior or pre-existing shipment paths 172. In one such an embodiment, as new shipping paths are created or accepted by the user 190 or other users for various freight units, the shipping paths may be sent to the shipping path storage 180 for future reference. In another embodiment, a user 190 or other user may manually create various shipping paths 172 and populate the shipping path storage 180. It is understood that the above are merely a few illustrative examples to which the disclosed subject matter is not limited.

Returning to the routing device 104, in one embodiment, in order to reduce computation time and/or to provide a better solution in the initialization phase, knowledge from a previous optimization (e.g., a prior version of improved shipping path 178) may be used in the current optimization process. Often freight units of similar types and constraints are transported from similar source locations to similar destination locations. In the illustrated embodiment, instead of choosing a random initial shipping path 174, the initialization phase or the shipment path initializer 112 may use the knowledge stored from previous optimizations to decide which vehicle and which route was previously used for this kind of freight unit in past scenarios. In various embodiments, this may lead to a less costly initial solution or shipping path 174 and may, in various embodiments, save computation time either for the second phase of optimization or reduce the computation time as a whole.

In various embodiments, the data collection involved in creating and maintaining the shipment path storage 180 may also be used for strategic planning purposes. In such an embodiment, a user 190 analyze the prior shipment paths 172 to determine what vehicles, companies, routes, etc. are frequently used or employed. In such an embodiment, user 190 may be able to discover and explorer cost savings or better service or results etc. In such an embodiment, the user 190 may employ a shipping path analyzer 156 to perform or facilitate this analysis. It is understood that the above are merely a few illustrative examples to which the disclosed subject matter is not limited.

In one embodiment, the shipment path selector 110 may be configured to examine the plurality of prior shipment paths 172 stored within the shipment path storage 180 and select a prior SP 172 to use as the initial SP 174. In such an embodiment, only a sub-set of plurality of prior shipment paths 172 may be considered candidate prior shipment paths 172 from which the shipment path selector 110 may select the initial SP 174. In some embodiments, the sub-set may be created or limited by the customer or user associated with the respective prior shipment paths 172, a time limit, a geographical limitation, etc. However, in another embodiment, the shipment path selector 110 may be configured to consider the entire plurality of prior SPs 172 as candidates for selection as the initial SP 174. It is understood that the above are merely a few illustrative examples to which the disclosed subject matter is not limited. In various embodiments, this selection or determination may be based upon one or more predefined criteria 175, as described below.

In various embodiments, the shipment path storage 180 may include or store for each prior shipping path 172 an associated freight unit or freight unit ticket 173 that made use of that shipment path 172. In some embodiments, multiple prior FUs 173 may be associated with a single prior sipping path, if multiple prior FUs 173 made use of that shipping path 172. In such an embodiment, the shipment path selector 110 may be configured to determine the similarity between the current FU information 158 and the various prior FUs 173.

In various embodiments, the shipment path selector 110 may be configured to compare a characteristic of the current freight unit 158 against a respective characteristic of a prior freight unit 173. In some embodiments, these characteristics may be physical (e.g., a weight of the respective freight unit, a volume of the respective freight unit, a fragility of the respective freight unit, etc.), logistical (e.g., a source of the respective freight unit, a destination of the respective freight unit, etc.), economic (e.g., shipping costs, etc.), temporal (e.g., a desired delivery date, etc.), or a different characteristic. It is understood that the above are merely a few illustrative examples to which the disclosed subject matter is not limited.

In such an embodiment, the shipment path selector 110 may ideally find one or more prior FUs 173 that are substantially identical to the current FU 158. For example the FUs 173 and 158 may include the same transported object (e.g., barrels of syrup, etc.) and the same source and destination locations, and differ in the time of shipment. In such an embodiment, the shipment path selector 110 may select the prior shipment path 172 associated with the most recent version of the substantially identical prior FU 173.

In another embodiment, the shipment path selector 110 may not find a substantially identical prior FU 173. In such an embodiment, the shipment path selector 110 may employ a scoring system (e.g., a weighted score, etc.) to determine a prior FU 173 that is sufficiently identical or most closely identical to the current FU 158. In such an embodiment, the shipment path selector 110 may consider the physical characteristics (e.g., weight, volume, girth, etc.) of the respective FUs to determine if a prior FU 173 is a good proxy for the current FU 158.

In such an embodiment in which a prior FU 173 is found to be sufficiently (based on the pre-defined criteria 175) similar to the current FU 158, the prior shipping path 172 associated with the similar prior FU 173 may be selected as the initialization shipping path 174. As described above, these prior shipment paths 172 may be the prior results of the optimization process.

In yet another embodiment, the shipment path selector 110 may not find any prior FUs 173 that are deemed to be sufficiently similar to the current FU 158. In such an embodiment, the shipment path initializer 112 may default to a random shipment path or other predefined technique, as described above, for determining an initial shipment path 174 that is deemed to be without precedent or have a sufficiently similar prior FU 173. In such an embodiment, the initial shipment path 174 may be considered an original shipment path as it is not associated with a prior FU 173.

In the illustrated embodiment, once an initial shipping path 174 is selected, the shipment path improver 114 may be configured to attempt to improve the shipping path to form or generate an improved shipping path 178. In such an embodiment, the shipment path improver 114 may be configured to apply an improvement technique, as described above.

In one embodiment, the shipment path improver 114 may be in communication with a route information storage 182. In such an embodiment, the route information storage 182 may include a plurality of route data 176. In some embodiments, the route data 176 may include information regarding a portion of a possible route. In some embodiments, the route data 176 may include information regarding a shipping channel (e.g., a road, a flight path, a boat's course, etc.), information regarding a carrier (e.g., the carrier company's name and contact information, the carrier company's fees, the carrier company's capacity or volume, the carrier company's vehicle types, etc.), etc.

In the illustrated embodiment, the shipment path improver 114 may be configured to alter or edit the initial shipping path 174 to improve it based on a set of predefined criteria 115. In one embodiment, the shipment path improver 114 may be configured to change one or more portions of the shipment path and to determine if this improves the shipment path or not.

For example, the shipment path improver 114 may replace legs or segments of the initial shipment path 174 that dictates that FU be transported by truck from point C to point D and then by truck from point D to point E with a new leg or segment that dictates that the FU be transported by plane from point C to point E. This new version or iteration of the shipment path may then be tested to determine if it is cheaper, quicker, more efficient, or otherwise “better” based upon criteria 115.

In various embodiments, these types of shipping path alterations or improvements may occur a number of times as the shipment path improver 114 iterates over a number of possible shipment paths as it attempts to improve upon the initial shipment path 174. In some embodiments, the number of iterations may be limited by the criteria 115. Such concluding criteria (illustrated as a portion of criteria 115) may include a limit to the amount of computation time (e.g., measured in processor cycles or actual time, etc.) or a measure of efficiency (e.g., a shipment cost, a time of delivery, etc.). It is understood that the above are merely a few illustrative examples to which the disclosed subject matter is not limited.

In various embodiments, once the concluding criteria have been met the most improved or optimized version of the shipping path may be considered the improved shipping path 178. In such an embodiment, this may be the shipping path 178 that the FU will take. In the illustrated embodiment, this improved shipping path 178 may be transmitted to the client device 102. In such an embodiment, the user 190 may then view the SP 178 via the application 148 or shipping path viewer 154. In some embodiments, the application 148 or shipping path viewer 154 may be configured to allow the user 190 to manually approve, reject, or edit the shipping path 178.

In one embodiment, the improved or final shipping path 178 may be transmitted to the storage device 106 for inclusion in the shipping path storage 180. In such an embodiment, the FU information 158 or a portion thereof may also be transmitted to the storage device 106 for inclusion in the shipping path storage 180. In such an embodiment, the current FU 158 and current improved shipping path 178 may then be used as a prior FU 173 and prior SP 172 when generating a subsequent shipping path in response to a subsequent shipping path request 159.

In various embodiments, the storage system 106 or the shipment path storage 180 may be used by a plurality of users or customers (e.g., user 191). In such an embodiment, the shipping path generator 120 may be configured to share prior shipping path 172 information between customers. In such an embodiment, a shipping request 159 by user 190 may result in the use of an initial shipping path 174 that was previously used by or generated for user 191. In another embodiment, the shipment path storage 180 may be configured to partition the storage 180 between users or customer, such that user 190 may make no use of data (e.g., FU 173 or SP 172, etc.) provided by or for user 191. In yet another embodiment, the shipment path storage 180 may be configured to allow limited data sharing (e.g., between users within the same conglomerate or company, between users subject to the same legal privacy laws, etc.). It is understood that the above are merely a few illustrative examples to which the disclosed subject matter is not limited.

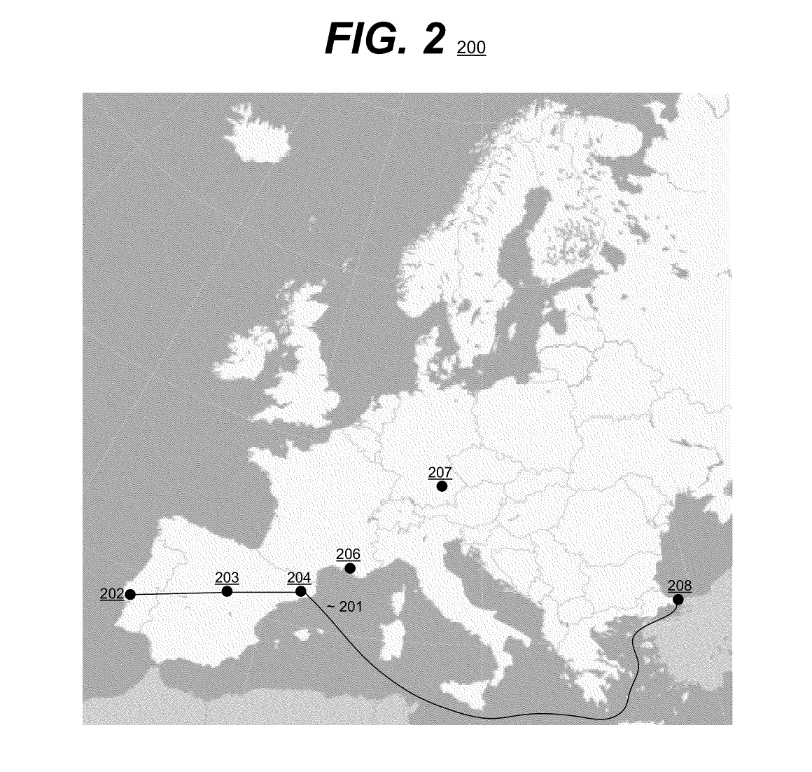

FIG. 2 is a diagram of an example embodiment of a shipment path 201 in accordance with the disclosed subject matter. FIG. 2 shows a map 200 of Europe. FIG. 2 also shows a shipping route 201 via which a freight unit (not shown) may travel from a source location 202 to a destination location 208. In the illustrated embodiment, a shipping route 201 selected by random or without the knowledge of a prior shipping route is shown.

Included on the map 200 are six cities or locations via which a freight unit may start its journey, pass through in its journey, or end its journey. These cities include Lisbon 202, Madrid 203, Barcelona 204, Marseilles 206, Munich 207, and Istanbul 208. In the illustrated embodiment, the freight unit starts or has a source location in Lisbon 202 and a destination location in Istanbul 208. It is understood that the above is merely one illustrative example to which the disclosed subject matter is not limited.

In the illustrated embodiment, the freight unit (e.g., rolls of paper, 20 foot equivalent unit (TEU) intermodal shipping/freight containers, etc.) is transported from Lisbon 202 to Madrid 203 by train, and then from Madrid 203 to Barcelona 204 by truck. From Barcelona 204 the freight unit may be shipped via boat directly to Istanbul 208. It is understood that the above is merely one illustrative example to which the disclosed subject matter is not limited.

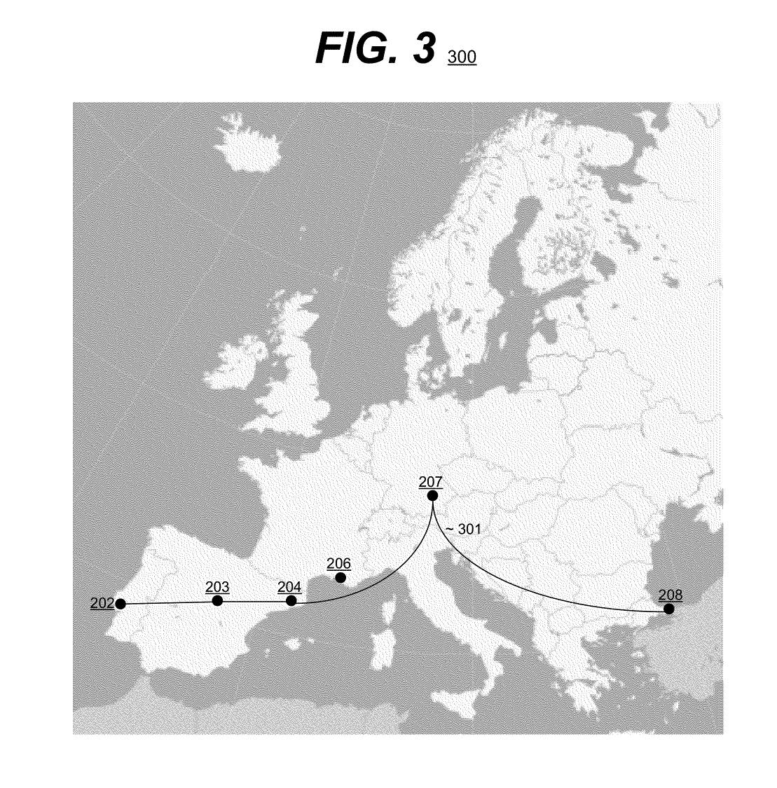

FIG. 3 is a diagram of an example embodiment of a shipment path 301 in accordance with the disclosed subject matter. FIG. 3 shows a map 300 of Europe. FIG. 3 also shows a shipping route 301 via which a freight unit (not shown) may travel from a source location 202 to a destination location 208. In the illustrated embodiment, a shipping route 301 may have been selected from amongst a plurality of prior or previously used shipping routes, as described above. In such an embodiment, this shipping route 301 may have been used to ship a freight unit similar to the current freight unit, as described above.

Included on the map 300 are six cities or locations via which a freight unit may start its journey, pass through in its journey, or end its journey. These cities include Lisbon 202, Madrid 203, Barcelona 204, Marseilles 206, Munich 207, and Istanbul 208. In the illustrated embodiment, the freight unit starts or has a source location in Lisbon 202 and a destination location in Istanbul 208. It is understood that the above is merely one illustrative example to which the disclosed subject matter is not limited.

In the illustrated embodiment, the freight unit (e.g., rolls of paper, 20 foot equivalent unit (TEU) intermodal shipping/freight containers, etc.) is again transported from Lisbon 202 to Madrid 203 by train, and then from Madrid 203 to Barcelona 204 by truck. However, in shipping path 301 the freight unit is flown from Barcelona 204 to Munich 207, and then flown from Munich 207 to Istanbul 208. It is understood that the above is merely one illustrative example to which the disclosed subject matter is not limited.

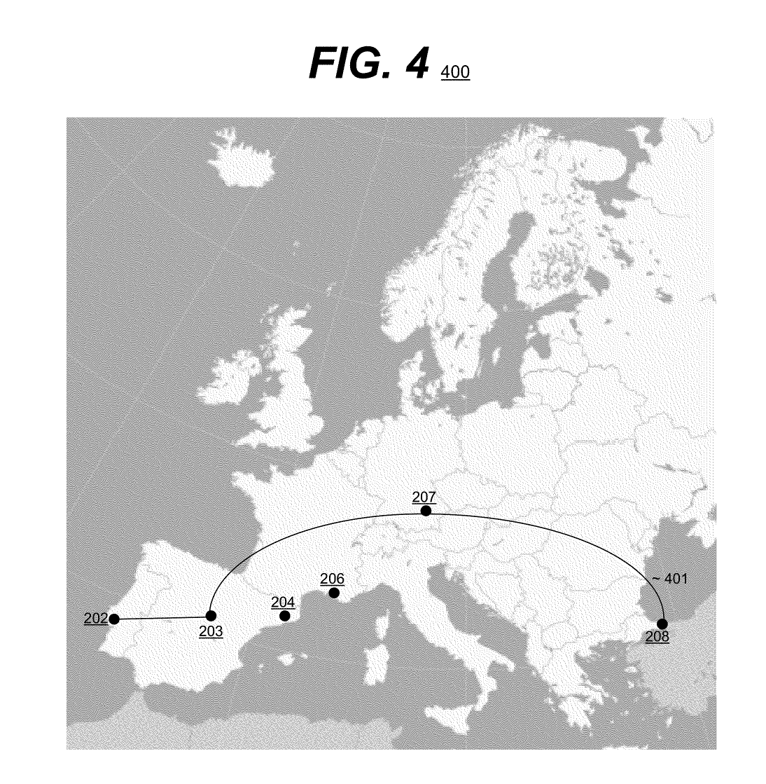

FIG. 4 is a diagram of an example embodiment of a shipment path 401 in accordance with the disclosed subject matter. FIG. 4 shows a map 400 of Europe. FIG. 4 also shows a shipping route 401 via which a freight unit (not shown) may travel from a source location 202 to a destination location 208. In the illustrated embodiment, a shipping route 401 may be the result of an optimization or improvement process, as described above. As described below, the shipping route 401 may be the final or improved shipping route 401 that started with, in different embodiments, initial shipping routes 201 or 301, as described below.

Included on the map 400 are six cities or locations via which a freight unit may start its journey, pass through in its journey, or end its journey. These cities include Lisbon 202, Madrid 203, Barcelona 204, Marseilles 206, Munich 207, and Istanbul 208. In the illustrated embodiment, the freight unit starts or has a source location in Lisbon 202 and a destination location in Istanbul 208. It is understood that the above is merely one illustrative example to which the disclosed subject matter is not limited.

In the illustrated embodiment, the freight unit (e.g., rolls of paper, 20 foot equivalent unit (TEU) intermodal shipping/freight containers, etc.) is again transported from Lisbon 202 to Madrid 203 by train. However, in shipping path 401 the freight unit is flown from Madrid 203 to Munich 207, and then flown from Munich 207 to Istanbul 208. It is understood that the above is merely one illustrative example to which the disclosed subject matter is not limited.

In the illustrated embodiments of FIGS. 2, 3, and 4, it can be seen that in order to generate shipping route 401 from shipping route 301 only one leg or segment of the shipping path 301 needs to be altered (the removal of the Madrid to Barcelona 204 segment). Conversely, if the shipping path generator begins with shipping route 201 a number of segments or legs of the shipping path must be altered. Further these alterations must occur both in locations or waypoint (e.g., adding a waypoint of Munich 207, deletion of the waypoint of Barcelona 204, etc.) and in forms of transportation (e.g., removing a segment that includes the use of a boat and adding two segments that includes the use of airplanes, etc.).

In such an embodiment, by starting with or initializing the shipping path generator with a prior shipment path 301 that had previously been generated by the optimization process, as opposed to the random shipment path 201, the computation time to achieve or generate an improved shipping path 401 may be reduced. It is understood that the above is merely one illustrative example to which the disclosed subject matter is not limited.

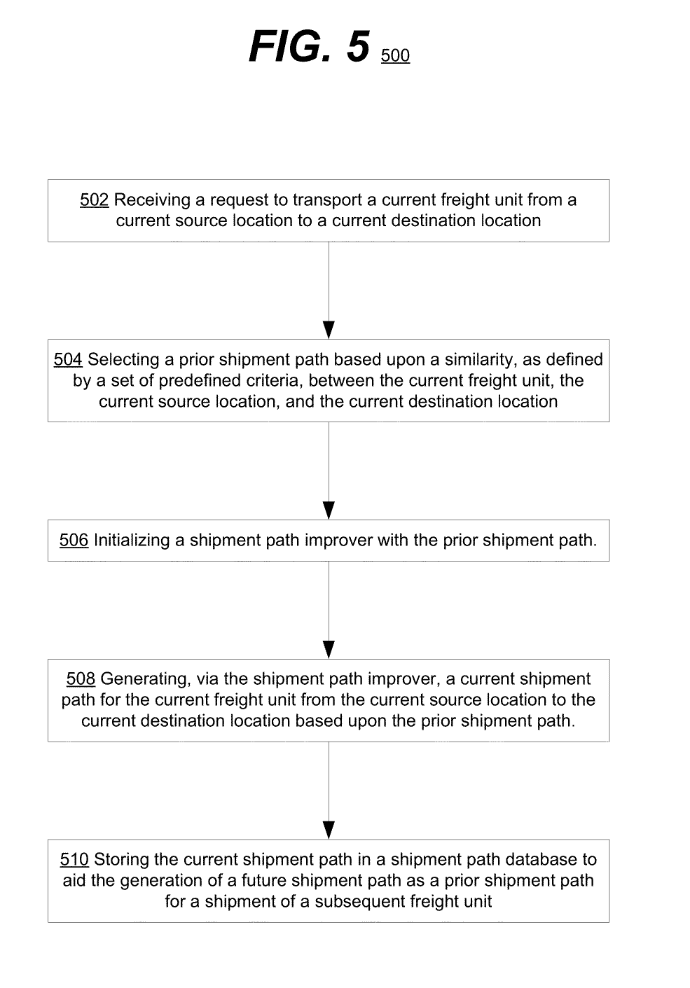

FIG. 5 is a flow chart of an example embodiment of a technique 500 in accordance with the disclosed subject matter. In various embodiments, the technique 500 may be used or produced by the systems such as those of FIG. 1. Furthermore, portions of technique 500 may be used or produced by the shipping routes such as that of FIG. 2, 3, or 4. Although, it is understood that the above are merely a few illustrative examples to which the disclosed subject matter is not limited. It is understood that the disclosed subject matter is not limited to the ordering of or number of actions illustrated by technique 500.

Block 502 illustrates that, in one embodiment, a request to transport a current freight unit from a current source location to a current destination location may be received. In various embodiments, one or more of the action(s) illustrated by this Block may be performed by the apparatuses or system of FIG. 1, and/or the shipment request receiver 116 of FIG. 1, as described above.

Block 504 illustrates that, in one embodiment, a prior shipment path may be selected based upon a similarity between the current freight unit, the current source, and the current destination, as described above. In various embodiments, the selection may be defined or based upon a set of predefined criteria, as described above. In some embodiments, selecting a prior shipment may include determining the similarity between the current freight unit and a prior freight unit that made use of a candidate prior shipment path, as described above. In such an embodiment, determining the similarity may include comparing a characteristic of the current freight unit against a respective characteristic of a prior freight unit, the characteristic selected from a group consisting of: a weight of the respective freight unit, a volume of the respective freight unit, a source of the respective freight unit, a destination of the respective freight unit, and a fragility of the respective freight unit, as described above. In one embodiment, the request to ship a current freight unit may be made by a first customer, and selecting a prior shipment path may include selecting a prior shipment path from a second customer, as described above. In various embodiments, one or more of the action(s) illustrated by this Block may be performed by the apparatuses or system of FIG. 1, the shipment path initializer 112 and/or the shipment path selector 110 of FIG. 1, as described above.

Block 506 illustrates that, in one embodiment, a shipment path optimizer or improver may be initialized with the prior shipment path, as described above. In various embodiments, if a prior shipment path is not similar, as defined by the set of predefined criteria, selecting an original shipment path to initialize the shipment path optimizer or improver, as described above. In some embodiments, selecting may include conducting an initialization phase in which an initial shipment path is selected. In various embodiments, one or more of the action(s) illustrated by this Block may be performed by the apparatuses or system of FIG. 1, the shipment path initializer 112 and/or the shipment path selector 110 of FIG. 1, as described above.

Block 508 illustrates that, in one embodiment, a current shipment path for the current freight unit from the current source to the current destination may be generated based upon the prior shipment path, as described above. In one embodiment, the current shipment path may include shipping the current freight unit by a plurality of different vehicle types, as described above. In some embodiments, generating may include conducting an optimization phase in which the initial shipment path is altered in order to improve, based on a predefined criteria, the current shipment path, as described above. In such an embodiment, the amount of computation used by the optimization phase when the initial shipment path is the prior shipment path may be less than an amount of computation used by the optimization phase when the initial shipment path is not a prior shipment path, as described above. In various embodiments, one or more of the action(s) illustrated by this Block may be performed by the apparatuses or system of FIG. 1, and/or the shipment path improver 114 of FIG. 1, as described above.

Block 510 illustrates that, in one embodiment, the current shipment path may be stored in a shipment path database to aid the generation of a future shipment path as a prior shipment path for a shipment of a subsequent freight unit, as described above. In various embodiments, one or more of the action(s) illustrated by this Block may be performed by the apparatuses or system of FIG. 1, the shipment path improver 114 and/or the shipment path storage 180 of FIG. 1, as described above.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
receiving a request to transport a current freight unit from a current source location to a current destination location;
selecting a prior shipment path based upon a similarity, as defined by a set of predefined criteria, between the current freight unit and a prior freight unit;
initializing a shipment path improver with the prior shipment path; and
generating, via the shipment path improver, a current shipment path for the current freight unit from the current source location to the current destination location based upon the prior shipment path.

2. The method of claim 1, further comprising:
storing the current shipment path in a shipment path database to aid the generation of a future shipment path as a prior shipment path for a shipment of a subsequent freight unit.

3. The method of claim 1, wherein selecting includes:
conducting an initialization phase in which an initial shipment path is selected; and
wherein generating includes:
conducting an improvement phase in which the initial shipment path is altered in order to improve, based on a predefined criteria, the current shipment path, and
wherein an amount of computation used by the improvement phase when the initial shipment path is the prior shipment path is less than an amount of computation used by the improvement phase when the initial shipment path is not a prior shipment path.

4. The method of claim 1, wherein selecting a prior shipment includes determining the similarity between the current freight unit and a prior freight unit associated with a candidate prior shipment path.

5. The method of claim 4, wherein the determining the similarity includes comparing a characteristic of the current freight unit against a respective characteristic of a prior freight unit, the characteristic selected from a group consisting of: a weight of the respective freight unit, a volume of the respective freight unit, a source of the respective freight unit, a destination of the respective freight unit, and a fragility of the respective freight unit.

6. The method of claim 1, wherein the current shipment path includes shipping the current freight unit by a plurality of different vehicle types.

7. The method of claim 1, further comprising:
if no prior shipment path is substantially similar, as defined by the set of predefined criteria, selecting an original shipment path.

8. The method of claim 1, wherein the request to ship a current freight unit is made by a first customer; and
selecting a prior shipment path includes selecting a prior shipment path that was previously generated for a second customer.

9. An apparatus comprising:
a network interface configured to:
receive a request to transport a current freight unit from a current source location to a current destination location; and
a processor configured to:
select a prior shipment path based upon a similarity, as defined by a set of predefined criteria, between the current freight unit and a prior freight unit,
initialize a shipment path improver with the prior shipment path; and
generate, via the shipment path improver, a current shipment path for the current freight unit from the current source location to the current destination location based upon the prior shipment path.

10. The apparatus of claim 9, further comprising:
a storage medium configured to store the current shipment path in a shipment path database to aid the generation of a future shipment path as a prior shipment path for a shipment of a subsequent freight unit.

11. The apparatus of claim 9, wherein the processor is configured to:
conduct an initialization phase in which an initial shipment path is used to initialize a data structure representing the initial shipment path;
conduct an improvement phase in which the initial shipment path is altered in order to improve, based on a predefined criteria, the current shipment path; and
wherein an amount of computation used by the improvement phase when the initial shipment path is the prior shipment path is less than an amount of computation used by the improvement phase when the initial shipment path is not a prior shipment path.

12. The apparatus of claim 9, wherein the processor is configured to determine the similarity between the current freight unit and a prior freight unit associated with a candidate prior shipment path.

13. The apparatus of claim 9, wherein the processor is configured to compare a characteristic of the current freight unit against a respective characteristic of a prior freight unit, the characteristic selected from a group consisting of: a weight of the respective freight unit, a volume of the respective freight unit, a source of the respective freight unit, a destination of the respective freight unit, and a fragility of the respective freight unit.

14. The apparatus of claim 9, wherein the current shipment path includes a route to ship the current freight unit by a plurality of different vehicle types.

15. The apparatus of claim 9, wherein the processor is configured to:
if a prior shipment path is not similar, as defined by the set of predefined criteria, generate an original shipment path.

16. The apparatus of claim 9, wherein the request to ship a current freight unit is made by a first customer; and
the processor is configured to select a prior shipment path that was previously generated for a second customer.

17. A computer program product for transportation management, the computer program product being tangibly and non-transitorily embodied on a computer-readable medium and including executable code that, when executed, is configured to cause an apparatus to:
receive a request to transport a current freight unit from a current source location to a current destination location;
select a prior shipment path based upon a similarity, as defined by a set of predefined criteria, between the current freight unit and a prior freight unit;
initialize a shipment path improver with the prior shipment path; and
generate, via the shipment path improver, a current shipment path for the current freight unit from the current source location to the current destination location based upon the prior shipment path.

18. The computer program product of claim 17, further comprising executable code that, when executed, is configured to cause an apparatus to:
store the current shipment path in a shipment path database to aid the generation of a future shipment path as a prior shipment path for a shipment of a subsequent freight unit.

19. The computer program product of claim 17, further comprising executable code that, when executed, is configured to cause an apparatus to:
conduct an initialization phase in which an initial shipment path is selected;
conduct an improvement phase in which the initial shipment path is altered in order to improve, based on a predefined criteria, the current shipment path; and
wherein an amount of computation used by the improvement phase when the initial shipment path is the prior shipment path is less than an amount of computation used by the improvement phase when the initial shipment path is not a prior shipment path.

20. The computer program product of claim 17, further comprising executable code that, when executed, is configured to cause an apparatus to:
determine the similarity between the current freight unit and a prior freight unit associated with a candidate prior shipment path.
